(19) United States
(12) Patent Application Publication
(10) Pub. No.: US 2002/0095332 A1
(43) Pub. Date: Jul. 18, 2002

(54) Internet advertisement system and method

(76) Inventors: Timothy K. Doherty, Costa Mesa, CA (US); James R. Dunlap, Anaheim, CA (US); John R. Petersen, Huntington Beach, CA (US); Tal Golan, Costa Mesa, CA (US); Julian C. Cummings, Huntington Beach, CA (US)

Correspondence Address: Pandiscio & Pandiscio, 470 Totten Pond Road, Waltham, MA, 02451-1914, US

(21) Appl. No.: 09/761,506

(22) Filed: Jan. 16, 2001

(51) Int. Cl. G06F 17/60

(52) U.S. Cl. 705/14; 705/27

(57) ABSTRACT

A novel Internet advertising system and method is provided in which a targeted advertisement is embedded into a multimedia presentation. In a preferred embodiment of the present invention, the targeted advertisement is chosen from a group of advertisements and is inserted into the presentation to an individual user based on the specifications of an advertiser. In another preferred embodiment, in addition to targeting the advertisement to an individual user, the advertisement embedded into the multimedia presentation is provided with a hyperlink to a website chosen by the advertiser.

### FIELD OF THE INVENTION

This invention relates to computer systems in general, and more particularly to Internet advertising systems. Even more particularly, this invention relates to apparatus and methods for advertising on the Internet.

### BACKGROUND OF THE INVENTION

Advertising on the Internet has become one of the most important sources of revenue for providers and syndicators of Web content.

Internet advertising generally consists of a banner advertisement presented to the user. These banner advertisements are a billboard which is separate from the provided content. The advertisement presented on the banner may be static, in that it comprises a fixed image, or the advertisement may be dynamic, in that it comprises a changing image. Often, the advertisement presented on the banner is overlooked, or even blocked by the user. As such, the effectiveness of banner advertising is of questionable merit.

Another problem associated with current Internet advertising relates to the degree to which the advertising itself can be targeted. More particularly, when banner advertisements are displayed in conjunction with highly specialized content, those particular advertisements will naturally have a high degree of targeting to a particular audience. However, when banner advertisements are displayed or in conjunction with broad based content, those banner applications will typically have a low degree of targeting to a particular audience.

### SUMMARY OF THE INVENTION

As a result, one object of the present invention is to provide a novel Internet advertising system in which a multimedia presentation contains a targeted advertisement to a user's demographic characteristics, whereby to increase the effectiveness of those advertisements.

Another object of the present invention is to provide a novel Internet advertising system which permits advertisements to be more closely targeted to a particular audience and to be dynamically embedded in a multimedia presentation.

Yet another object of the present invention is to provide a hyperlink to a sponsor's website in a targeted advertising.

Still another object of the present invention is to provide a novel Internet advertising system which can be used by content providers, syndication networks, media buyers, and others, to generate revenue.

And still another object of the present invention is to provide a novel Internet advertising method which can be used by content providers, syndication networks and media buyers, and others, to generate revenue.

In one form of the invention, the novel Internet advertising system comprises a multimedia presentation containing an embedded placeholder, a set of advertisements corresponding to the embedded placeholder with each advertisement being indexed by at least one demographic indicator, means for identifying at least one demographic characteristic of a user, means for selecting one advertisement from the set of advertisements having the most relevance to the user, means for inserting the selected advertisement into the embedded placeholder of the multimedia presentation, and means for delivering the multimedia presentation to the user.

Furthermore, since the advertisement contained in the multimedia presentation is not part of the underlying stored program, but is rather one of a set of advertisements stored separately from the underlying program itself, the advertisement may be provided based on a demographic analysis of the user or based on other requirements imposed by a sponsor or media buyer. For example, if a user is of a particular demographic, the advertisement contained on a T-shirt in the multimedia presentation may read “NIKE”. For another user of another demographic, the advertisement contained on the T-shirt in the multi-media presentation may read “COKE”.

In another embodiment of the invention, the novel advertising system provides a hyperlink in a targeted advertisement to a sponsor's website. By clicking on the targeted advertisement, the sponsor's website is opened in an Internet browser.

### BRIEF DESCRIPTION OF THE DRAWING

These and other objects and features of the present invention will be more fully disclosed by the following detailed description of the invention, which is to be considered together with the associated drawings wherein like numbers refer to like parts and further wherein:

FIG. 1 is a schematic illustration of a novel Internet advertising system formed in accordance with the present invention;

FIG. 2 is an illustration of a screen capture of the present invention having an embedded placeholder;

FIG. 3 is an illustration of a computer window of the present invention having several advertisements corresponding with an embedded placeholder;

FIG. 4 is a schematic illustration of a novel Internet advertising system formed in accordance with the present invention;

FIG. 5 is an illustration of a screen capture of the present invention having two embedded placeholders; and

FIG. 6 is an illustration of a computer window having several advertisements corresponding to a second embedded placeholder of the present invention.

### DETAILED DESCRIPTION OF THE INVENTION

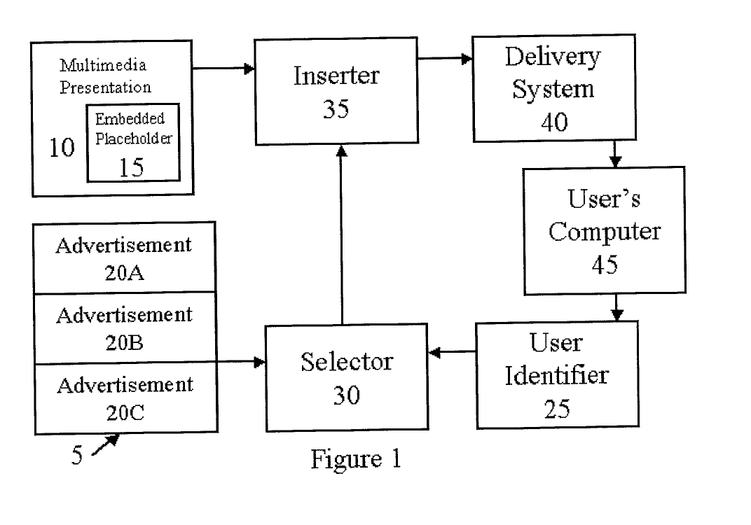

Referring to FIGS. 1-6, there is shown an Internet advertising system 5. Internet advertising system 5 generally comprises a multimedia presentation 10 containing an embedded placeholder 15; a set of advertisements 20A, 20B, 20C corresponding to embedded placeholder 15, with each advertisement 20A, 20B, 20C indexed to at least one demographic indicator; a user identifier 25; a selector 30 to choose one of the advertisements 20A, 20B, 20C based on its indexed demographic indicator(s) and the user identifier 25; an inserter 35 to dynamically embed the chosen advertisement 20 into multimedia presentation 10; and a delivery system 40 to send multimedia presentation 10 to a user's computer 45.

Looking now at FIG. 1, Internet advertising system 5 is schematically shown. In a preferred embodiment of the invention, multimedia presentation 10 is created using a Web authoring tool. A commercially available Web authoring tool, or another specially designed program, is used to create multimedia presentation 10. For example, one commercially available Web authoring tool is Macromedia's Flash Authoring Tool. Macromedia Flash is used by a Web author to produce multimedia presentation 10. Embedded placeholder 15 is also inserted into multimedia presentation 10 where advertisement 20 will appear. Existing multimedia presentations 10 may also be updated by inserting an embedded placeholder 15 similar to a newly created multimedia presentation 10. A Web authoring tool, such as Macromedia Flash, may be used for this insertion.

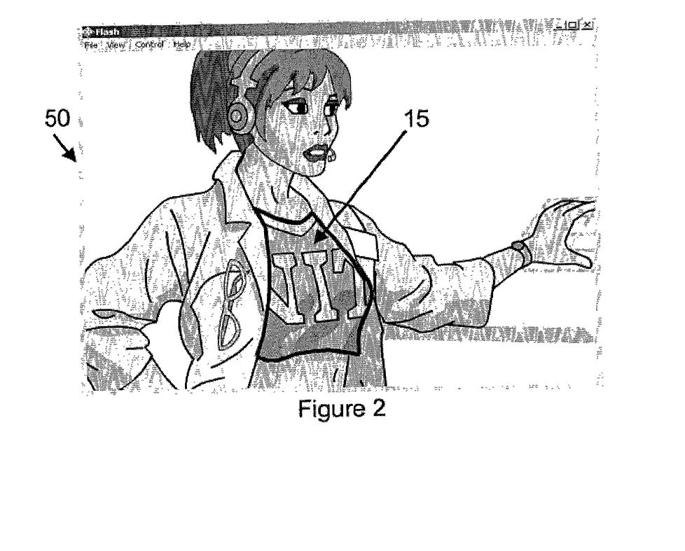

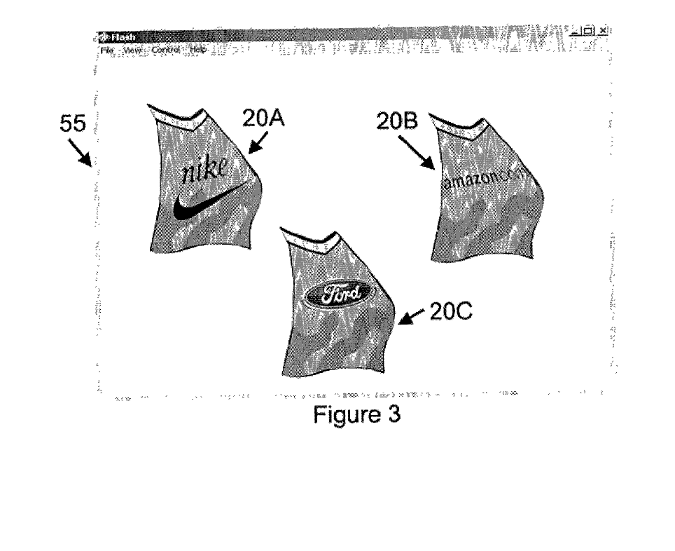

Looking now at FIGS. 2 and 3, in multimedia presentation 10 there are many possible configurations of embedded placeholder 15 and advertisement 20. For example, advertisement 20 could appear on a relatively static placeholder 15, such as a street billboard (not shown), or a more complex placeholder 15, such as a character's tee-shirt 15 (see FIG. 2) in a screen capture 50. Several advertisements 20A, 20B, 20C (see FIG. 3) are produced to correspond with the character's tee-shirt placeholder 15 (see FIG. 2). These advertisements 20A, 20B, 20C in a screen capture 55, are shown statically. However, in a preferred embodiment, the tee-shirt advertisements 20A, 20B, 20c are programmed to dynamically follow the character's actions.

Referring now to FIG. 1, user identifier 25 is transmitted from user's computer 45 to selector 30. User identifier 25 is then analyzed to ascertain one or more demographic characteristics of the user. For example, one user identifier 25 are cookies generated by the user's Internet browser. These cookies may contain information about previous Web sites visited and Information submitted by the user. This information is then analyzed by selector 30. Another example is a user completed survey answering questions which may include demographic information such as age, income and interests. The survey may be completed immediately prior to receiving media presentation 10 and thereby creating user identifier 25. Alternatively, the survey may be completed at another time or location and stored on a server. This stored survey is then accessed by Internet advertising system 5 to create user identifier 25.

Still looking at FIG. 1, in a preferred embodiment of the invention, selector 30 compares user identifier 25 with the indexed demographic indicator(s) of advertisements 20A, 20B 20C to select the most relevant advertisement for the user. Selector 30 may be implemented using various tools. One such tool is a Macromedia Generator server which receives user identifier 25 and then selects the most appropriate advertisement 20. The server may be one or more machines owned and run by the company supplying multimedia presentation 10, by a distribution or syndication company, a destination site, or a third party server company such as Beam. Other tools include, but are not limited to, off the shelf programs and programs written using known principles for making a comparison as described above and then selecting one advertisement 20 of advertisements 20A, 20B, 20C.

Still looking at FIG. 1, in a preferred embodiment of the invention, inserter 35 inserts selected advertisement 20 info embedded placeholder 15 to create a seamless advertisement which is dynamically contained in multimedia presentation 10 and targeted to the characteristics of user identifier 25. For example, a Macromedia Generator computer program may be used as inserter 35. Alternatively, other computer programs, either off the shelf or specifically created, may be used as inserter 35.

Referring still to FIG. 1, delivery system 40 is shown for sending multimedia presentation 10 having an embedded advertisement 20 to user's computer 45. In a preferred embodiment of the invention, delivery system 40 is an Internet connection between the site where multimedia presentation 10 is stored and the user's computer 10. In another preferred embodiment of the invention, delivery system 40 is a syndication network. A syndication network supplies information or content, such as multimedia presentation 10, to one or more Websites for publication. Here, the syndication network 40 collects multimedia presentation 10 and selected advertisement 10 and delivers these to the user's computer 45, syndication network 40 may collect multimedia presentation 10 containing selected advertisement 20 already inserted therein; alternatively, syndication network 40 may collect multimedia presentation 10 and selected advertisement 20 separate from one another and merge them together prior to delivery at user's computer 45.

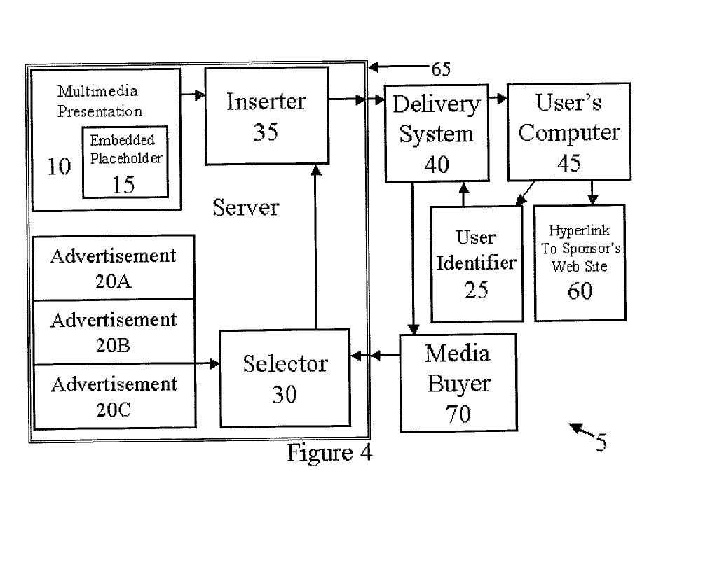

Now looking at FIG. 4, a preferred embodiment of the invention is shown in which Internet advertising system 5 includes a hyperlink 60 in selected advertisement 20 contained in multimedia presentation 10; a server 65 storing multimedia presentation 10, advertisements 20A, 20B, 20C selector 30, and inserter 35; and a media buyer component 70 supplying information from user identifier 25 delivered by delivery system 40.

Still looking at FIG. 4, hyperlink 60 is located on the selected advertisement 20 delivered to the user's computer 45. Hyperlink 60 corresponds to the sponsor's website of the selected advertisement 20. As such, invoking hyperlink 60 opens the sponsor's Web site. This action of invoking hyperlink 60 may also be reported within Internet advertising system 5 to charge the sponsor not only for providing hyperlink 60 but also for the user's demonstrated interest shown by invoking hyperlink 60.

Referring now to FIG. 4, server 65 is shown having multimedia presentation 10, advertisements 20A, 20B, 20C, selector 30, and inserter 35. In this configuration, server 65 uses the Macromedia Generator computer program to store multimedia presentation 10 and advertisements 20A, 20B, 20C. Generator server 65 also functions as selector 30 and inserter 35 in accordance with information sent through delivery system 40 and media buyer component 70.

This selection is then relayed to server 65 for insertion of advertisement 20 into multimedia presentation 10.

Looking now at FIGS. 1 and 4, the total number of each advertisement 20 inserted into multimedia presentations 10, and viewed by the user, is logged by Internet advertising system 5. The number of displays of each advertisement 20 may be logged within selector 30 or, when appropriate, in server 65. This stored number of displays is then used to charge sponsors according to the number of views presented. The revenue generated by these charges is then divided between the owner of delivery system 40, such as a syndication company, the owner of media buyer component 70, such as a media buy company, and the owner of multimedia presentation 20, such as Internet content provider.

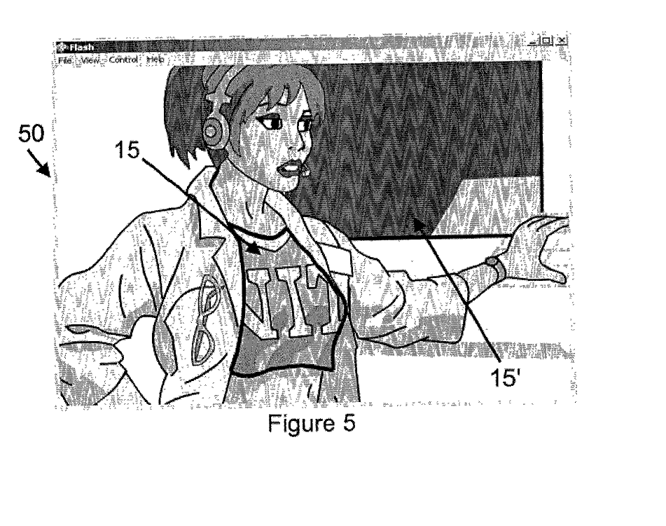

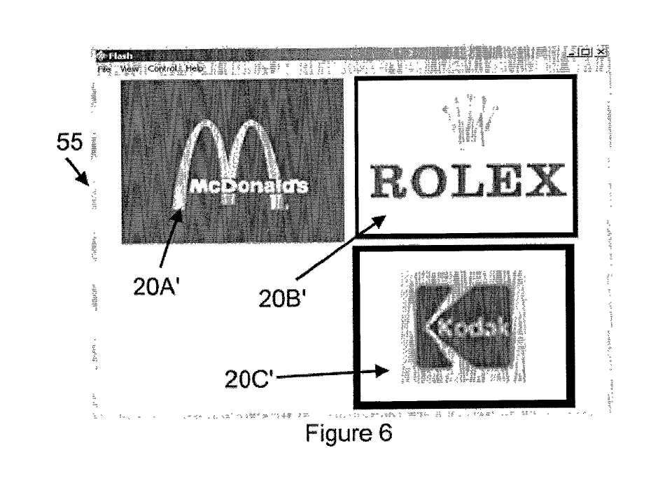

Looking now at FIGS. 5 and 6, there is shown a screen capture 55 having tee-shirt placeholder 15 and another placeholder 15′ for a billboard type advertisement from a group of advertisements 20A′, 20B′, 20C′ corresponding to placeholder 15′. The present invention is not limited to one or two placeholders 15, 15′ and is also not limited to three advertisements 20, 20′.

Alternatively, another preferred embodiment of the Internet advertising system 5 does not rely on the demographics of a user to target advertisements. In this embodiment, the selector 30 may randomly select advertisement 20 or be pre-programmed concerning the selection of advertisement 20.

It should, of course, be appreciated that the present invention is by no means limited to the particular construction and method steps disclosed above and/or shown in the drawings, but also comprises any modifications or equivalents within the scope of of claims.

What is claimed is:

1. An Internet advertising system comprising:
a multimedia presentation containing an embedded placeholder;
a set of advertisements corresponding to the embedded placeholder, each advertisement being indexed by at least one demographic indicator;
means for identifying at least one demographic characteristic of a user;
means for selecting one advertisement from the set of advertisements, the selector means including a comparison of the user's at least one demographic characteristic with the at least one demographic indicator of each advertisement to select the most relevant advertisement for the user;
means for inserting the selected advertisement into the embedded placeholder of the multimedia presentation, the inserter means creating a seamless advertisement dynamically contained in the multimedia presentation and targeted to the user's demographic characteristics; and
means for delivering the multimedia presentation to the user.

2. The system of claim 1 further comprising a hyperlink in the advertisement contained in the multimedia presentation.

3. The system of claim 2 wherein the hyperlink in the advertisement is a hyperlink to an advertiser's website.

4. The system of claim 1 wherein the multimedia presentation is an animation.

5. The system of claim 4 wherein the animation is created using Flash.

6. The system of claim 5 wherein the Flash animation is an original presentation.

7. The system of claim 5 wherein the Flash animation is a pre-existing presentation and the embedded placeholder is then added to the pre-existing presentation.

8. The system of claim 1 wherein the multimedia presentation includes at least two embedded placeholders.

9. The system of claim 8 further comprising multiple sets of advertisements, each set of advertisements corresponding to one of the at least two embedded placeholders.

10. The system of claim 1 wherein the identifier means includes cookies generated by an Internet browser of the user.

11. The system of claim 1 wherein the identifier means includes a survey completed by the user.

12. The system of claim 1 wherein the inserter means is a computer program.

13. The system of claim 1 wherein the computer program is Generator.

14. The system of claim 12 wherein the computer program is stored on a first server and the multimedia presentation containing the embedded placeholder is also stored on the first server.

15. The system of claim 12 wherein the computer program is stored on a first server and the multimedia presentation containing the embedded placeholder is stored on a second server.

16. The system of claim 1 wherein the delivery means is an Internet connection between a first server storing the multimedia presentation containing the embedded placeholder and a computer operated by the user.

17. The system of claim 16 further comprising a syndication network.

18. The system of claim 17 wherein the syndication network collects the multimedia presentation and the selected advertisement, and the syndication network delivers the multimedia presentation containing the selected advertisement to the user's computer.

19. The system of claim 18 wherein the syndication network collects the multimedia presentation and the selected advertisement separate from one another, and a server in the syndication network inserts the selected advertisement into the multimedia presentation.

20. The system of claim 18 wherein the syndication network collects the multimedia presentation having the selected advertisement inserted therein previous to entering the syndication network.

21. The system of claim 18 wherein the syndication network collects information relating to the identifier means from the user's computer and delivers the identifier information to the selector means.

22. The system of claim 1 further comprises a media buyer providing at least a portion of the set of advertisements.

23. The system of claim 22 wherein the media buyer receives information relating to the identifier means from the user's computer.

24. The system of claim 21 wherein the identifier information from the syndication network is further delivered to a media buyer.

25. The system of claim 24 wherein the identifier information is delivered from the syndication network to the media buyer and from the media buyer to the selector means.

26. The system of claim 24 wherein the identifier information is delivered from the syndication network to the media buyer and the identifier information is also delivered from the syndication network to the selector means.

27. The system of claim 1 further comprising an advertisement charge to the sponsor of the selected advertisement delivered in the multi-media presentation.

28. The system of claim 27 wherein the sponsor's advertising charge is paid to an owner of the multimedia presentation.

29. The system of claim 27 wherein the sponsor's advertisement charge is apportioned to a group comprising an owner of the multimedia presentation and an owner of a media buyer providing the selected advertisement.

30. The system of claim 29 wherein the sponsor's advertisement charge is apportioned to a group comprising an owner of the multimedia presentation, an owner of a media buyer providing the inserted advertisement, and an owner of the delivery means for providing the multimedia presentation to the user.

31. The system of claim 30 wherein the delivery means is a syndication network.

32. An Internet advertising system comprising:
a multimedia presentation containing an embedded placeholder;
a set of advertisements corresponding to the embedded placeholder;
means for selecting one advertisement from the set of advertisements;
means for inserting the selected advertisement into the embedded placeholder of the multimedia presentation, the inserter means creating a seamless advertisement contained in the multimedia presentation; and
means for delivering the multimedia presentation to a user.

33. The system of claim 32 wherein the selector randomly selects the advertisement.

34. The system of claim 32 wherein the seamless advertisement is dynamically contained in the multimedia presentation.

35. An Internet advertising system comprising:
an original, Flash animation multimedia presentation containing at least one embedded placeholder;
multiple sets of advertisements, each set of advertisements corresponding to one of each of the at least two embedded placeholders, and each advertisement being indexed by at least one demographic indicator;
cookies generated by an Internet browser of a user for identifying at least one demographic characteristic of the user;
means for selecting one advertisement from the set of advertisements, the selector means including a comparison of the user's cookies with the at least one demographic indicator of each indexed advertisement to select the most relevant advertisement for the user;
a Macromedia Generator computer program for inserting the selected advertisement into the embedded placeholder of the multimedia presentation, the Generator computer program creating a seamless advertisement dynamically contained in the multimedia presentation and targeted to the user's demographic characteristics;
a syndication network for delivering the multimedia presentation to the user over an Internet connection between a first server storing the multimedia presentation containing the embedded placeholder and a computer operated by the user;
a media buyer providing at least a portion of the set of advertisements, wherein the identifier information is delivered from the syndication network to the media buyer and the identifier information is also delivered from the syndication network to the selector means;
a fee charged to the user for delivery of the multimedia presentation, the user fee being apportioned to a group comprising an owner of the multimedia presentation, an owner of the syndication network and an owner of the media buyer;
an advertisement charge to the sponsor of the advertisement delivered in the multi-media presentation, wherein the sponsor's advertisement charge is apportioned to a group comprising an owner of the multimedia presentation, an owner of a media buyer providing the selected advertisement, and an owner of the delivery means for providing the multimedia presentation to the user; and
a hyperlink in the advertisement contained in the multimedia presentation, wherein the hyperlink takes the user to an advertiser's website.

36. An Internet advertising method comprising:
providing a multimedia presentation containing an embedded placeholder;
providing a set of advertisements corresponding to the embedded placeholder, each advertisement being indexed by at least one demographic indicator;
identifying at least one demographic characteristic of a user;
selecting one advertisement from the set of advertisements, the advertisement selection includes a comparison of the user's at least one demographic characteristic with at least one demographic indicator of each advertisement, wherein the most relevant advertisement for the user is selected;
inserting the selected advertisement into the embedded placeholder of the multimedia presentation, wherein a seamless advertisement dynamically contained in the multimedia presentation and targeted to the user's demographic characteristics is created; and
means for delivering the multimedia presentation to the user.

37. An Internet advertising method comprising:
providing an original, Flash animation multimedia presentation containing at least two embedded placeholders;
providing multiple sets of advertisements, each set of advertisements corresponding to one of each of the at least two embedded placeholders, and each advertisement being indexed by at least one demographic indicator;
identifying cookies generated by an Internet browser of a user, wherein at least one demographic characteristic of the user is identified;
selecting one advertisement from the set of advertisements, the selector means including a comparison of the user's cookies with the at least one demographic indicator of each indexed advertisement to select the most relevant advertisement for the user;
inserting the selected advertisement into the embedded placeholder of the multimedia presentation using a Macromedia Generator computer program, the Generator computer program creating a seamless advertising dynamically contained in the multimedia presentation and targeted to the user's demographic characteristics;
providing a syndication network for delivering the multimedia presentation to the user over an Internet connection between a first server storing the multimedia presentation containing the embedded placeholder and a computer operated by the user;
providing at least a portion of the set of advertisements through a media buyer, wherein the identifier information is delivered from the syndication network to the media buyer and the identifier information is also delivered from the syndication network to the selector means;
charging a fee to the user for delivery of the multimedia presentation, the user fee being apportioned to a group comprising an owner of the multimedia presentation, an owner of the syndication network and an owner of the media buyer;
charging the sponsor of the advertisement delivered in the multi-media presentation, wherein the sponsor's advertisement charge is apportioned to a group comprising an owner of the multimedia presentation, an owner of a media buyer providing the selected advertisement, and an owner of the delivery means for providing the multimedia presentation to the user; and
a hyperlink in the advertisement contained in the multimedia presentation, wherein the hyperlink takes the user to an advertiser's website.
